(19) United States
(12) Patent Application Publication
(10) Pub. No.: US 2025/0086681 A1
(43) Pub. Date: Mar. 13, 2025

(54) VEHICLE QR CODE TYPE PARKING CARD ON WHICH QR CODE IS PRINTED AND QR CODE TYPE PARKING CARD APPLICATION SYSTEM FOR CONTACTING DRIVER BY SCANNING QR CODE

(71) Applicant: Min Kyu KIM, Incheon (KR)

(72) Inventor: Min Kyu KIM, Incheon (KR)

(21) Appl. No.: 18/728,052

(22) PCT Filed: Jul. 19, 2022
(86) PCT No.: PCT/KR2022/010480

§ 371 Date: Jul. 10, 2024

(30) Foreign Application Priority Data
Jan. 10, 2022 (KR) 10-2022-0003669

(51) Int. Cl. G06Q 30/02; G06K 19/06

(52) U.S. Cl. CPC G06Q 30/0281; G06K 19/06037

(57) ABSTRACT

The present invention relates to a vehicle QR code type parking card on which a QR code is printed and a QR code type parking card application system for contacting a driver by scanning a QC code, and a method for contacting a driver by using the vehicle QR code type parking card on which the QR code is printed, according to an embodiment of the present invention, comprises: scanning, by a caller, the QR code printed on the QR code type parking card to access a QC code type parking card application; retrieving, from a DB, a license plate number matching a unique identification number of the scanned QR code type parking card; confirming, by the caller, the retrieved license plate number; sharing his/her current location information with the driver; confirming, by the driver, a shared location of the caller; retrieving, from the DB, a contact number of the driver if the driver accepts a connection request from the caller; and connecting the caller and the driver.

### TECHNICAL FIELD

The present invention relates to a QR code type parking card on which a QR code is printed, which is to be installed in a vehicle, and a QR code type parking card application system for allowing a caller to make contact with a driver having a QR code type parking card installed in a vehicle, in which a caller scans the QR code and a QR code type parking card application is accessed to retrieve, from DB, a license plate number matching a unique identification number of the QR code type parking card and a contact number of the driver, and share a current location of the caller with the driver.

### BACKGROUND ART

Currently, a parking number plate for a vehicle refers to an accessory for a vehicle which is installed with a contact number of a driver marked thereon so that the driver may be contacted in his/her absence or when there is no person who may make contact with the driver inside the vehicle or near the parked vehicle.

Since the conventional parking number plate is installed in a state in which the driver's contact number is always exposed, there is a problem that the contact number may be abused for crimes due to leakage of personal information.

In addition, when the contact number of the driver is changed, the conventional parking number plate causes an inconvenience of correcting the marked contact number and reinstalling the parking number plate with the contact number corrected.

### DISCLOSURE

### Technical Problem

The present invention has been applied to solve a personal information security problem of a conventional parking number plate, in which a contact number of a driver is always exposed, and an object of the present invention is to protect personal information and to prevent crimes caused by the leakage of personal information.

The present invention has been applied to solve a problem of the conventional parking number plate, which causes an inconvenience of correcting the marked contact number and reinstalling the parking number plate, when the contact number of the driver is changed, and another object of the present invention is to conveniently correct the contact number of the driver connected to a QR code type parking card without a physical change of the QR code type parking card installed in a vehicle by correcting the contact number registered in the QR code type parking card application system described in the present invention when the contact number of the driver is changed.

### Technical Solution

To achieve the objects as described above, in a QR code type parking card application system for making contact with a driver by scanning a QR code according to one aspect of the present invention, a method for allowing a caller to make contact with a driver having a QR code type parking card installed in a vehicle may include: scanning, by a caller, the QR code type parking card installed in a vehicle, in which the QR code is scanned to access the QR code type parking card application and retrieve, from DB, a license plate number matching a unique identification number of the scanned QR code type parking card; confirming, by the caller, the license plate number, in which the caller confirms the license plate number of the QR code type parking card registered in the QR code type parking card application; sharing a current location of the caller with a driver; confirming, by the driver, a shared location of the caller; retrieving, from the DB, a contact number of the driver, matching the unique identification number of the scanned QR code type parking card, upon the acceptance for a connection request from the caller; and connecting the caller and the driver.

### Advantageous Effects

The present invention relates to a vehicle QR code type parking card on which a QR code is printed and a QR code type parking card application system for making contact with a driver by scanning a QC code, and more specifically, to a QR code type parking card on which a QR code is printed, which is to be installed in a vehicle, and a QR code type parking card application system for allowing a caller to make contact with a driver by scanning a QR code printed in the QR code type parking card, in which personal information can be protected by exposing only the QR code without exposing a contact number of the driver, and crimes caused by the leakage of personal information can be prevented by copying only the QR code of the QR code type parking card to request a connection at a location other than a parking location of the vehicle, because a current location of the caller is shared with the driver and the driver can identify the location of the caller, when the caller makes a connection request to the driver.

In addition, when the contact number of the driver is changed, the contact number registered in the QR code type parking card application can be corrected without physical correction of the contact number marked on the QR code type parking card, thereby allowing the changing of the contact number in association with the QR code type parking card.

### DESCRIPTION OF DRAWINGS

FIG. 1 is an exemplary view of showing a vehicle QR code type parking card on which a QR code is printed according to one embodiment of the present invention.

FIG. 1 is an exemplary view of showing a vehicle QR code type parking card on which a QR code is printed according to one embodiment of the present invention. FIG. 2 is a view of showing a configuration of a vehicle QR code type parking card on which a QR code is printed and a QR code type parking card application system for making contact with a driver by scanning a QC code according to one embodiment of the present invention.

FIG. 2 is a view of showing a configuration of a vehicle QR code type parking card on which a QR code is printed and a QR code type parking card application system for making contact with a driver by scanning a QC code according to one embodiment of the present invention. FIG. 3 is a flowchart for explaining an example of a vehicle QR code type parking card on which a QR code is printed and a QR code type parking card application system for making contact with a driver by scanning a QC code according to one embodiment of the present invention. FIG. 3 is a flowchart for explaining an example of a vehicle QR code type parking card on which a QR code is printed and a QR code type parking card application system for making contact with a driver by scanning a QC code according to one embodiment of the present invention.

### MODE FOR INVENTION

Hereinafter, preferred embodiments of the present invention will be described in detail with reference to the accompanying drawings.

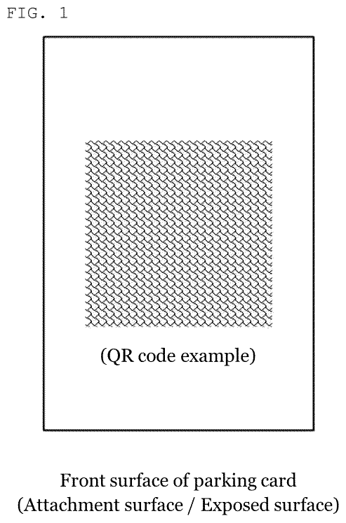

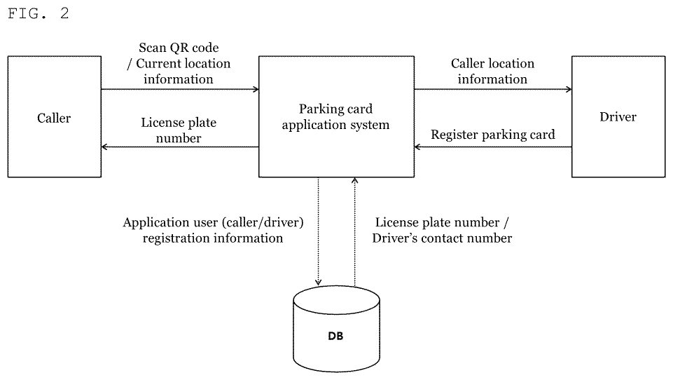

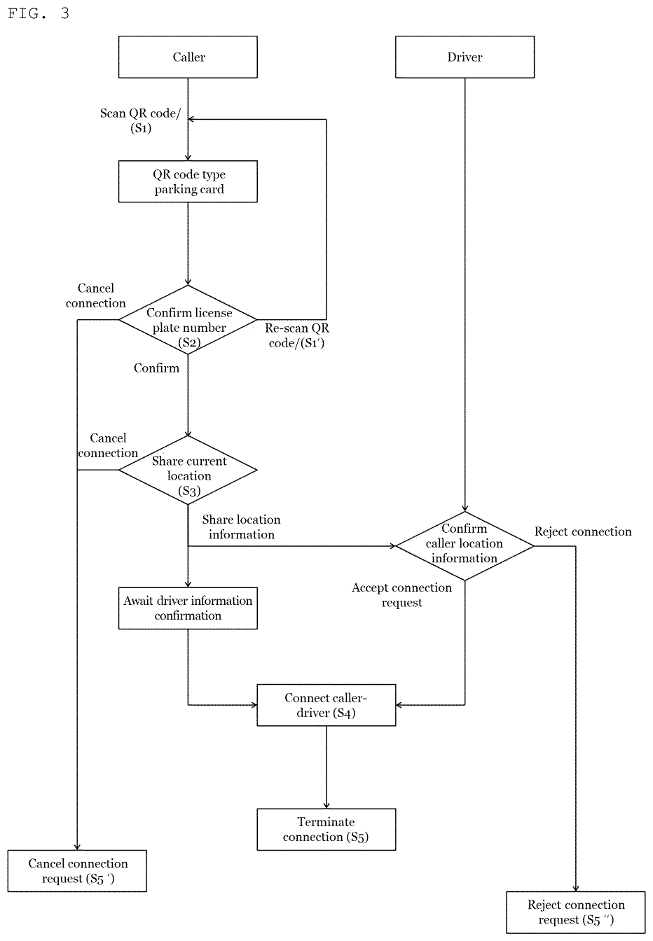

Referring to FIGS. 1 and 2, a vehicle QR code type parking card on which a QR code is printed and a QR code type parking card application system for making contact with a driver by scanning a QC code according to one embodiment of the present invention may include: a card unit including a parking card 100, a QR code 101, and a unique identification number 102; and an application unit including a QR code type parking card application 200 and DB 201.

The QR code 101 may be marked on an attachment surface in which the QR code type parking card 100 is installed in a vehicle so as to be exposed to outside, and may allow a caller 220 to easily scan.

The unique identification number 102 may refer to the number which is different from the number of other QR code type parking cards 100, and may be matched with a license plate number 212 and a contact number 211 of a driver so as to be stored in DB, and when the caller 220 scans the QR code type parking card, the QR code type parking card application 200 may be accessed to retrieve, from the DB 201, the license plate number 212 and the contact number 211 of the driver, which match the unique identification number 102 of the QR code type parking card 100.

The DB 201 may include information about a driver 210 including the license plate number 212, the contact number 211 of the driver, and the unique identification number 102, and when information is retrieved from the DB 201 according to stages of making a connection between the caller 220 of the QR code type parking card application 200 and the driver 210, the unique identification number 102 may be a search value of data stored in the DB 201.

Referring to FIG. 1, a vehicle QR code type parking card on which a QR code is printed and a QR code type parking card 100 of a QR code type parking card application system for making contact with a driver by scanning a QR code according to one embodiment of the present invention may be configured such that a QR code 101 is marked on one face thereof, the face on which the QR code 101 is marked is an attachment face, and the attachment face is exposed to outside when installed in a vehicle, thereby allowing the caller 220 to easily scan the QR code 101 of the QR code type parking card 100.

Referring to FIG. 2, the caller 220 may access the QR code type parking card application 200 through a QR code scan of the QR code type parking card 100, the QR code type parking card application 200 may retrieve the license plate number 212 and the contact number 211 of the driver which match the unique identification number 102 of the accessed QR code type parking card from the DB 201, a current location 221 of the caller may be shared with the driver 210, and the driver 210 may confirm the current location 221 of the shared caller to make contact with the caller 220.

Referring to FIG. 3, the method may include: S1 of scanning, by the caller 220, the QR code 101 printed on the QR code type parking card 100 installed in a vehicle to access the QR code type parking card application 200; S2 of retrieving, from DB, the license plate number 212 matching the unique identification number 102 of the accessed QR code type parking card 100 and confirming, by the caller 220, the license plate number 212 registered in the QR code type parking card application 200; S3 of sharing the current location 221 of the caller with the driver 210; S4 of confirming, by driver 210, the shared current location 221 of the caller and accepting a connection request from the caller 220 to retrieve, from the DB 201, the contact number 211 of the driver and make a connection between the caller 220 and the driver 210; and S5 of terminating the connection.

In this case, the caller 220 may select S1′ of re-scanning the QR code 101 or S5′ of canceling the connection request to the driver while performing S1 and S2.

In addition, S3 may include select S5″ of confirming, by the driver 210, the shared current location 221 of the caller and rejecting the connection request from the caller 220 to terminate the connection.

1. A vehicle QR code type parking card apparatus on which a QR code is printed, wherein the vehicle QR code type parking card apparatus has the QR code printed thereon and
when installed in a vehicle, the marked QR code is installed to be exposed to outside so that a caller who desires to make contact with a driver of a vehicle easily scans the QR code.

2. The vehicle QR code type parking card apparatus of claim 1, wherein the QR code marked on a QR code type parking card functions that, when the caller scans the QR code of the QR code type parking card, the caller is able to access a QR code type parking card application, and
when driver information stored in DB is searched and retrieved according to stages of making a connection between the caller and the driver, a unique identification number that is a data search value is shared in the QR code type parking card application.

3. A method for connecting a caller and a driver by using a vehicle QR code type parking card on which a QR code is printed, the method comprising:
scanning, by a caller, the QR code type parking card installed in a vehicle;
confirming, by the caller, a license plate number of the QR code type parking card registered in a QR code type parking card application;
sharing a current location of the caller with a driver;
confirming, by the driver, a shared current location of the caller;
selecting, by the driver, a connection request from the caller;
retrieving a contact number of the driver; and
making a connection between the caller and the driver.

4. The method of claim 3, wherein the confirming, by the caller, of the license plate number of the QR code type parking card registered in the QR code type parking card application includes retrieving, from DB, a license plate number matching a unique identification number of the scanned QR code type parking card and sharing the retrieved license plate number with the caller.

5. The method of claim 3, wherein the sharing of the current location of the caller with the driver and confirming, by the driver, of the shared current location of the caller include sharing current location information of the caller with the driver so that the driver confirms the shared location information.
